(19) United States
(12) Patent Application Publication
(10) Pub. No.: US 2026/0181383 A1
(43) Pub. Date: Jun. 25, 2026

(54) PRIVACY AND UE LOCATION VERIFICATION FOR A NON-TERRESTRIAL NETWORK

(71) Applicant: LENOVO (SINGAPORE) PTE. LTD., Singapore (SG)

(72) Inventors: Sheeba Backia Mary BASKARAN, Friedrichsdorf (DE); Robin Rajan THOMAS, Bad Nauheim (DE); Hyung-Nam CHOI, Ottobrunn (DE); Sher Ali CHEEMA, Ilmenau (DE); Andreas KUNZ, Ladenburg (DE); Konstantinos SAMDANIS, Munich (DE)

(21) Appl. No.: 19/124,761

(22) PCT Filed: Dec. 9, 2022
(86) PCT No.: PCT/EP2022/085177

§ 371 Date: Apr. 25, 2025

(30) Foreign Application Priority Data
Nov. 4, 2022 (GR) 20220100906

(51) Int. Cl. H04W 12/02; H04W 60/00; H04W 64/00; H04W 84/06

(52) U.S. Cl. CPC H04W 12/02; H04W 60/001; H04W 64/00; H04W 84/06

(57) ABSTRACT

There is provided a method comprising: receiving an NI message from a user equipment “UE” over a Non-Terrestrial Network “NTN” service; sending a get request to a UDM which includes UE ID, NTN service type and an indication for a privacy information check; receiving a get response from the UDM with UE ID, NTN service type, and privacy information; and responding to the NI message based on the received privacy information.

### FIELD

The subject matter disclosed herein relates generally to the field of implementing privacy and UE location verification for a non-terrestrial network. This document defines an apparatus and a method.

### BACKGROUND

In a 5G wireless communication system, a UE may use next generation radio (NR) satellite access. An Access and Mobility Management Function (AMF) in the network may request and receives UE location related data from the radio access network to perform UE location verification to determine if the public land mobile network is allowed to operate at the present UE location. Such a check may be required to meet certain regulatory requirements. If the AMF determines that the UE is not allowed to operate at the UE location, the AMF either rejects any NAS request from the UE or if the UE is already registered, the AMF initiates a de-registration for the UE.

Non-Terrestrial Networks (NTN) are defined in 3GPP as any network that involves non-terrestrial flying objects. NTN services may be delivered via satellite communication networks, high altitude platform systems (HAPS), and air-to-ground networks.

### SUMMARY

For Non-Terrestrial Network (NTN) services such as satellite access, user consent is required for UE location data to be collected by the NG-RAN and/or AMF. If user consent is not granted, then the AMF cannot verify the UE location. However, if an AMF in the PLMN allows satellite access without any UE location verification, then it can violate the applicable regulatory requirements. Of course, the methods and apparatus described herein are applicable to UE connected by way of a Non-public network (NPN) as well as a PLMN. Indeed, the methods and apparatus described herein may be applicable to any mobile operator network such as PLMN, or an NPN, for example.

Disclosed herein are procedures for privacy and UE location verification for a non-terrestrial network. Said procedures may be implemented by an apparatus, such as an AMF.

There is provided an apparatus comprising a transceiver; and a processor coupled to the transceiver. The processor and the transceiver configured to cause the apparatus to: receive an N1 message from a user equipment “UE” over a Non-Terrestrial Network “NTN” service; send a get request to a UDM which includes UE ID, NTN service type and an indication for a privacy information check; receive a get response from the UDM with UE ID, NTN service type, and privacy information; and responding to the N1 message based on the received privacy information.

There is further provided a method comprising: receiving an N1 message from a user equipment “UE” over a Non-Terrestrial Network “NTN” service; sending a get request to a UDM which includes UE ID, NTN service type and an indication for a privacy information check; receiving a get response from the UDM with UE ID, NTN service type, and privacy information; and responding to the N1 message based on the received privacy information.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for implementing privacy and UE location verification for a non-terrestrial network will now be described, by way of example only, with reference to the accompanying drawings, in which:

FIG. 1 depicts an embodiment of a wireless communication system for implementing privacy and UE location verification for a non-terrestrial network;

FIG. 2 depicts a user equipment apparatus that may be used for implementing the methods described herein;

FIG. 3 depicts further details of the network node that may be used for implementing the methods described herein;

FIG. 4 shows a non-roaming reference architecture for Location Services in reference point representation;

FIG. 5 illustrates an RRC state transition notification between an NG-RAN and an AMF;

FIG. 6 illustrates an NG-RAN Location Reporting Procedure between an NG-RAN and an AMF;

FIG. 7 illustrates a 5GC Network Induced Location Request (5GC-NI-LR) for a UE;

FIG. 8 illustrates a method for accessing and verifying UE location based on privacy and regulatory enforcement information;

FIG. 9 illustrates a method for managing UE privacy information collection and revocation for location sharing related to satellite access/NTN Service; and

FIG. 10 illustrates a method as described herein.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

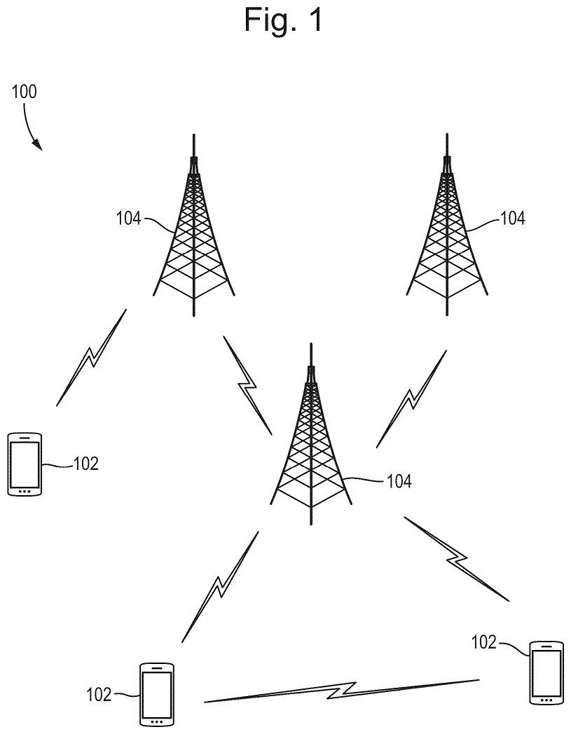

FIG. 1 depicts an embodiment of a wireless communication system 100 for implementing privacy and UE location verification for a non-terrestrial network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

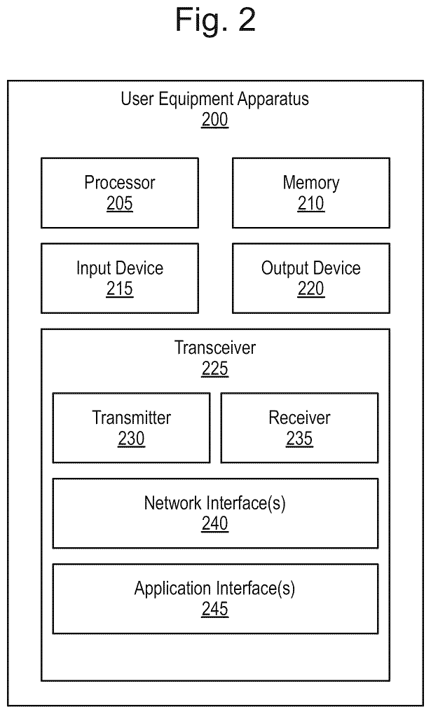

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a remote unit 102, or a UE 410, 710, 810, 910 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

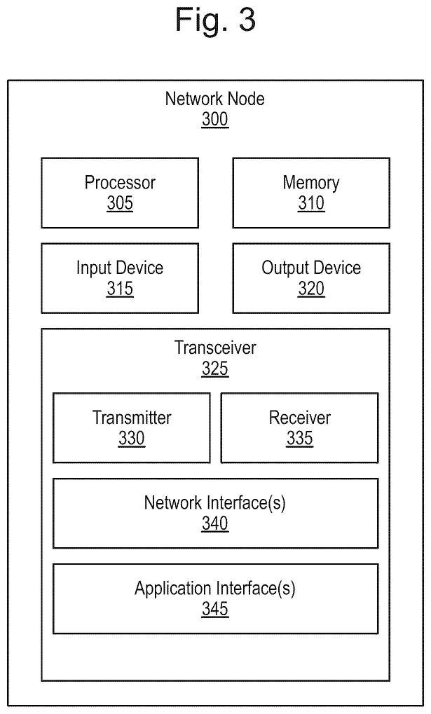

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise an AMF 430, 530, 630, 730, 830, 930 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

According to 3GPP TS 38.300 v17.2.0 titled “NR; NR and NG-RAN Overall Description”, Clause 16.14—‘Non-Terrestrial Networks’, and Clause 16.14.8—‘Coarse UE location reporting’, upon network request, after Access Stratum security is established in connected mode, a UE should report its coarse UE location information (most significant bits of the Global Navigation Satellite System (GNSS) coordinates, ensuring an accuracy in the order of 2 km) to the NG-RAN if available.

According to 3GPP TS 23.273 v17.6.0 titled “5G System (5GS) Location Services (LCS); Stage 2”, Clause 4.1—‘General Concepts’ states that for location request from an LCS client (neither in the UE nor in the NG-RAN) or AF external to a PLMN or SNPN, privacy verification of the target UE shall be enabled to check whether it is allowed to acquire the UE location information based on UE LCS privacy profile and whether the LCS client or the AF is authorised to use the location service as defined in clause 5.4. Additionally, UEs may optionally support privacy notification and verification on behalf of a user. Privacy override is also supported for regulatory LCS services according to local regulation.

3GPP TS 23.273 v17.6.0 Clause 4.1a.1—‘Network Induced Location Request (NI-LR)’ states that with a Network Induced Location Request (NI-LR), a serving AMF for a UE initiates localization of the UE for a regulatory service (e.g. an emergency call from the UE) or for verification of a UE location (country or international area) for NR satellite access.

3GPP TS 23.273 v17.6.0 Clause 4.3.6—‘UDM’ states that the UDM contains LCS subscriber LCS privacy profile and routing information. The UDM is accessible from an AMF, GMLC or NEF via the Nudm interface.

3GPP TS 23.273 v17.6.0 Clause 4.3.7—‘Access and Mobility Management Function, AMF’ states that the AMF contains functionality responsible for managing positioning for a target UE for all types of location request. The AMF is accessible to the GMLC and NEF via the Namf interface, to the RAN via the N2 reference point and to the UE via the N1 reference point. Functions which may be performed by an AMF to support location services include the following: Initiate an NI-LR location request for a UE with an IMS emergency call or to know a UE geographical area with NR satellite access for PLMN selection verification; and Receive updated privacy requirements from a UE and transfer to a UDR via UDM.

3GPP TS 23.273 v17.6.0, Clause 4.3.8—‘Location Management Function, LMF’ states that the LMF manages the overall co-ordination and scheduling of resources required for the location of a UE that is registered with or accessing 5GCN. It also calculates or verifies a final location and any velocity estimate and may estimate the achieved accuracy. The LMF receives location requests for a target UE from the serving AMF using the Nlmf interface. The LMF interacts with the UE in order to exchange location information applicable to UE assisted and UE based position methods and interacts with the NG-RAN, N3IWF or TNAN in order to obtain location information. The LMF shall determine the result of the positioning in geographical co-ordinates as defined in TS 23.032 and/or in local co-ordinates as defined in TS 23.032. NOTE 1: Some RAT independent position methods (e.g. GNSS based position methods) can only determine a UE location in geographical co-ordinates. In such a case, the LMF may translate a UE location in geographical co-ordinates into a location in local co-ordinates when an origin for the local co-ordinates has known global coordinates. Additional functions which may be performed by an LMF to support location services include the following.
Support a request for a single location received from a serving AMF for a target UE.
Support a request for periodic or triggered location received from a serving AMF for a target UE.
Determine type and number of position methods and procedures based on UE and PLMN capabilities, QoS, UE connectivity state per access type, LCS Client type, co-ordinate type and optionally service type.
Report UE location estimates directly to a GMLC for periodic or triggered location of a target UE.
Support of receiving stored UE Positioning Capability from AMF and support of providing updated UE Positioning Capability to AMF.
Map the UE location to a geographical area where the PLMN is or is not allowed to operate based on the request from AMF.

3GPP TS 23.273 v17.6.0, Clause—4.3.10 ‘Unified Data Repository, UDR’ states that the UDR contains privacy data information for target UEs and may be updated by a serving AMF via UDM with new privacy information received from a UE.

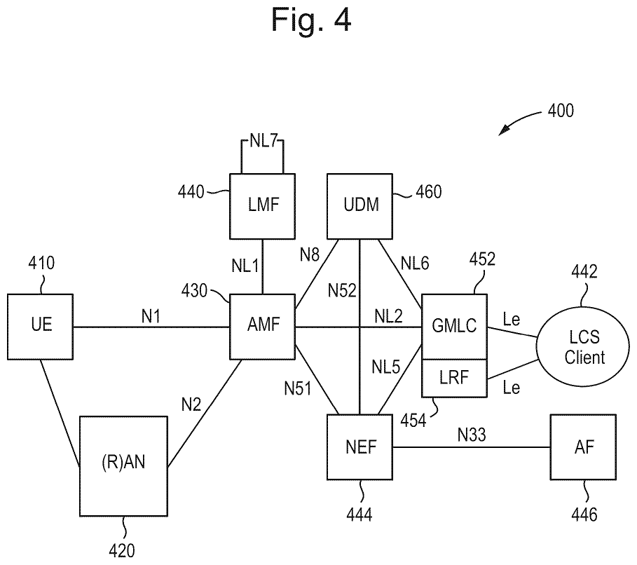

FIG. 4 shows a non-roaming reference architecture for Location Services in reference point representation. A wireless communication system 400 comprises a user equipment (UE) 410, a Radio Access Network (RAN) 420 an Access and Mobility Management Function (AMF) 430, a Location Management Function (LMF) 440, a GMLC/LRF 450, a Unified Data Management (UDM) 460, a LoCation Services (LCS client 442, a Network Exposure Function (NEF) 444, and an Application Function (AF) 446. The GMLC/LRF 450 may comprise a Gateway Mobile Location Centre (GMLC) 452 and an Location Retrieval Function (LRF) 454. The interfaces used for communication between the various elements of the system are labelled (e.g., N1, N2 etc. . . . ). The UE 410 may comprise a remote unit 102, a user equipment apparatus 200, or a UE 710, 810, 910 as described herein. The AMF 430 may comprise a network node 300, or an AMF 530, 630, 730, 830, 930 as described herein.

3GPP TS 23.273 v17.6.0, Clause—4.4.3 ‘N1 Reference Point’ states that the N1 reference point supports transfer of supplementary services messages between a serving AMF and target UE to support privacy notification and verification and change of UE privacy preference.

3GPP TS 23.273 v17.6.0, Clause—4.4.4 ‘N2 Reference Point’ states that the N2 reference point supports transfer of positioning messages, via an AMF, between an LMF and a RAN node, or N3IWF in the case of untrusted non-3GPP access.

3GPP TS 23.273 v17.6.0, Clause—4.4.10 ‘NL1 Reference Point’ states that the NL1 reference point supports location requests for a target UE sent from a serving AMF for the target UE to an LMF. Location requests are supported for immediate location and for deferred location for periodic or triggered location events.

3GPP TS 23.501 v17.6.0 is titled “System architecture for the 5G System (5GS); Stage 2”, and Clause 5.4.7—‘NG-RAN location reporting’ thereof states that NG-RAN supports the NG-RAN location reporting for the services that require accurate cell identification (e.g. emergency services, lawful intercept, charging) or for the UE mobility event notification service subscribed to the AMF by other NFs. The NG-RAN location reporting may be used by the AMF when the target UE is in CM-CONNECTED state. The NG-RAN location reporting may be used by the AMF to determine the geographically located TAI in the case of NR satellite access. If the AMF requests UE location, in the case of NR satellite access, the NG-RAN provides all broadcast TAIs to the AMF as part of the ULI. The NG-RAN also reports the TAI where the UE is geographically located if this TAI can be determined. The AMF requests the location information of the UE either through independent N2 procedure (i.e. NG-RAN location reporting as specified in clause 4.10 of TS 23.502 [4]), or by including the request in some specific N2 messages as specified in TS 38.413.

3GPP TS 23.501 v17.6.0, Clause 5.4.11.4 ‘Verification of UE location’ states that in order to ensure that the regulatory requirements are met, the network may be configured to enforce that the selected PLMN is allowed to operate in the current UE location by verifying the UE location during Mobility Management and Session Management procedures. In this case, when the AMF receives a NGAP message containing User Location Information for a UE using NR satellite access, the AMF may decide to verify the UE location. If the AMF determines based on the Selected PLMN ID and ULI (including Cell ID) received from the gNB that it is not allowed to operate at the present UE location the AMF should reject any NAS request with a suitable cause value. If the UE is already registered to the network when the AMF determines that it is not allowed to operate at the present UE location, the AMF may initiate deregistration of the UE. The AMF should not reject the request or deregister the UE unless it has sufficiently accurate UE location information to determine that the UE is located in a geographical area where the PLMN is not allowed to operate. NOTE: The area where the UE is allowed to operate can be determined based on the regulatory area where the PLMN is allowed to operate based on its licensing conditions.

3GPP TS 23.501 v17.6.0, Clause 5.4.11.4 goes on: if the AMF, based on the ULI, is not able to determine the UE's location with sufficient accuracy to make a final decision, the AMF proceeds with the Mobility Management or Session Management procedure and may initiate UE location procedure after the Mobility Management or Session Management procedure is complete, as specified in clause 6.10.1 of TS 23.273, to determine the UE location. The AMF shall be prepared to deregister the UE if the information received from LMF indicates that the UE is registered to a PLMN that is not allowed to operate in the UE location. In the case of a NAS procedure, the AMF should either reject any NAS request targeted towards a PLMN that is not allowed to operate in the known UE location and indicate a suitable cause value, or accept the NAS procedure and initiate deregistration procedure once the UE location is known. In the deregistration message to the UE, the AMF shall include a suitable cause value. For UE processing of the cause value indicating that the PLMN is not allowed to operate in the current UE location, see TS 23.122 and TS 24.501. In the case of a handover procedure, if the (target) AMF determines that it is not allowed to operate at the current UE location, the AMF either rejects the handover, or accepts the handover and later deregisters the UE.

3GPP TS 23.501 v17.6.0, Clause 5.4.11.5—‘Network selection for NR satellite access’ states that network selection principles specified in clause 5.2.2 apply also for NR satellite access. For NR satellite access, a UE with location capability should use its awareness of its location to select a PLMN that is allowed to operate in the UE location as specified in TS 23.122. In order to ensure that the regulatory requirements are met, the network may be configured to enforce this UE choice by verifying the UE location, as described in clause 5.4.11.4.

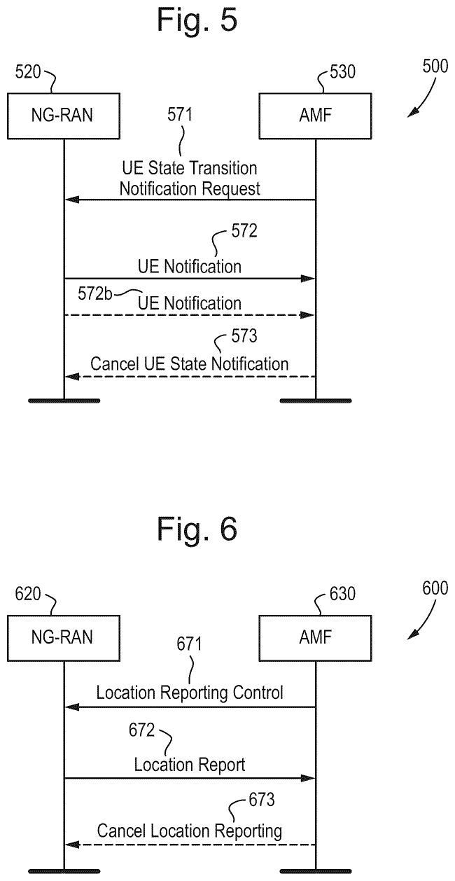

FIG. 5 illustrates an RRC state transition notification between an NG-RAN 520 and an AMF 530. The AMF 530 may comprise a network node 300, or an AMF 430, 630, 730, 830, 930 as described herein. The process 500 commences at 571 with a UE state transition notification request sent from the AMF 530 to the NG-RAN 520. At 572, the NG-RAN 520 sends a UE notification to the AMF. Optionally, further UE notifications may follows as 722b. At 573, the NG-RAN 520 receives a Cancel US state notification from the AMF 573. 3GPP TS 23.502 v17.6.0 titled “Procedures for the 5G System (5GS); Stage 2”, Clause 4.8.3—‘N2 Notification procedure’ describes the above procedure 500 as being used by an AMF 530 to request the NG-RAN 520 to report RRC state information, when the target UE is in CM-CONNECTED state. Reporting of RRC state transitions can be requested per UE by AMF 530. Continuous reporting of all RRC state transitions can be enabled by operator local configuration.

FIG. 6 illustrates an NG-RAN Location Reporting Procedure 600 between an NG-RAN 620 and an AMF 630. The AMF 630 may comprise a network node 300, or an AMF 430, 530, 730, 830, 930 as described herein. 3GPP TS 23.502 v17.6.0, Clause 4.10—‘NG-RAN Location reporting procedures’ describes such a procedure as being used by an AMF to request the NG-RAN to report where the UE is currently located when the target UE is in CM-CONNECTED state. The need for the NG-RAN to continue reporting ceases when the UE transitions to CM-IDLE or the AMF sends cancel indication to NG-RAN. This procedure may be used for services that require accurate cell identification (e.g. emergency services, lawful intercept, charging), or for subscription to the service by other NFs. When Dual Connectivity is activated, PSCell information is only reported if requested by the AMF.

The procedure 600 commences at 671, with the AMF 630 sending to NG-RAN 620: Location Reporting Control (Reporting Type, Location Reporting Level, (Area Of Interest, Request Reference ID)).

At 672, the NG-RAN 620 sends to AMF 630: Location Report (UE Location, UE Presence in Area Of Interest, Request Reference ID, Timestamp). The NG-RAN sends a Location Report message informing the AMF about the location of the UE which shall be represented as the requested Location Reporting Level. If PSCell reporting is requested and Dual Connectivity is activated, then the Master NG-RAN node shall also include the PSCell ID. With NR satellite access, cell and TAI reporting by NG-RAN refer to a fixed cell and fixed TA in which a UE is geographically located. As part of the User Location Information, NG_RAN also reports one or more TACs for the Selected PLMN as described in TS 38.413, but it is not guaranteed that the UE is always located in one of these TACs.

At 673, the AMF 630 sends to NG-RAN 620: Cancel Location Report (Reporting Type, Request Reference ID).

3GPP TS 23.502 v17.6.0 describes, at Clause 5.2.3.3 Nudm_SubscriberData-Management (SDM) Service, and an excerpt from table 5.2.3.3.1-1: UE Subscription data types is reproduced therefrom below as table 1.

TABLE 1
UE Subscription data types

| Subscription | | |
|---|---|---|
| data type | Field | Description |
| LCS privacy | LCS privacy | Provides information for LCS privacy |
| (data needed | profile data | classes and Location Privacy Indication |
| by GMLC) | | (LPI) as defined in clause 5.4.2 in |
| | | TS 23.273 |
| LCS mobile | LCS Mobile | When present, indicates to the serving |
| origination | Originated | AMF which LCS mobile originated |
| (data needed | Data | services are subscribed as defined in |
| by AMF) | | clause 7.1 in TS 23.273 |

3GPP TS 23.502 v17.6.0 describes, at Clause 5.2.3.6 Nudm_ParameterProvision service, stating that this service is for allowing NEF to provision of information which can be used for the UE in 5GS. An excerpt from table 5.2.3.6.1-1: Parameter Provision data types is reproduced therefrom below as table 2.

TABLE 2
Parameter Provision data types

| Parameter Provision | |
|---|---|
| data type | Description |
| Location Privacy | Location Privacy Indication parameters of the |
| Indication parameters | “LCS privacy” Data Subset of the |
| | Subscription Data. |
| | See clause 5.2.3.3.1 and clause 7.1 of |
| | TS 23.273 |

3GPP TS 23.502 v17.6.0 describes, at Clause 5.2.12 UDR services, stating that the following Data Set Identifiers shall be considered in this release: Subscription Data, Policy Data, Application data and Data for Exposure. An excerpt from table 5.2.12.1-2 Exposure data stored in the UDR is reproduced therefrom below as table 3.

TABLE 3
Exposure data stored in the UDR

| | | | | |
|---|---|---|---|---|
| | | | | Data |
| | Infor- | | Data | Sub |
| Category | mation | Description | key | key |

| | | | |
|---|---|---|---|
| Access and | UE | Gives the Location or the last | SUPI |
| mobility | location | known location of a UE (e.g. | or |
| information | | Tai, Cell Id . . . both 3GPP | GPSI |
| | | and non-3GPP access location) | |

3GPP TS 23.501 v17.6.0 titled “System architecture for the 5G System (5GS); Stage 2”, Clause 5.16.4—‘Emergency Services’ states that for NR satellite access, if a UE in limited service state is aware of its location, the UE selects a PLMN that is allowed to operate in the UE location as specified in 3GPP TS 23.122.

3GPP TS 23.273 v17.6.0 titled “5G System (5GS) Location Services (LCS); Stage 2”, Clause 5.4—‘UE LCS privacy’, and ‘Clause 5.4.1 General’ state that an LCS client or AF may or may not be authorised to retrieve the UE location, e.g. for commercial use. UE LCS privacy is a feature which allows a UE and/or AF to control which LCS clients and AFs are and are not allowed access to UE location information. UE LCS privacy can be supported via subscription and via UE LCS privacy profile handling. With subscription, privacy preferences for a UE are stored in a UE LCS privacy profile as part of UE subscription data in the UDM and queried from the UDM by another NF such as GMLC or NEF. The UDM may also store the UE privacy profile in the UDR. In this release of the specification, subscription of privacy preferences is restricted to the Call/Session unrelated Class as defined in clause 5.4.2.2.3 and the PLMN Operator Class as defined in clause 5.4.2.2.4.

3GPP TS 23.273 v17.6.0 goes on with UE LCS privacy profile handling, the UE and/or AF can provide and update part of the UE privacy profile and provide it to the network as an update to the UDR. In this release of the specification, UE LCS privacy profile handling is restricted to the Location Privacy Indication as defined in clause 5.4.2.3. The UE LCS privacy profile is used to indicate whether LCS requests from LCS clients and AFs are allowed or disallowed, together with the POI as defined in clause 5.4.4. NOTE: In clause 5.4, even if the UE LCS privacy detail is only described for LCS client, the same detail is also applicable for AF, if no exception statement.

3GPP TS 23.273 v17.6.0, Clause 5.4.2—‘Content of UE LCS Privacy Profile’, and Clause 5.4.2.1—‘General’ states that the UE LCS privacy profile also includes the Location Privacy Indication, as defined in clause 5.4.2.3, which can be provided and updated by the UE and/or AFs.

3GPP TS 23.273 v17.6.0, Clause 5.4.2.2.3—‘Call/Session unrelated Class’ states: The call/session unrelated class defined in clause 9.5.3.3 of TS 23.271 is supported for a 5GC-MT-LR. The subscription options for the Call/Session unrelated Class may be assigned to an identified value added LCS Client, AF, value added LCS Client group or service type as described in clause 7.1 and comprise one of the following alternatives:
positioning allowed without notifying the UE user (default case);
positioning allowed with notification to the UE user;
positioning requires notification and verification by the UE user; positioning is allowed only if granted by the UE user or if there is no response to the notification;
positioning requires notification and verification by the UE user; positioning is allowed only if granted by the UE user.

3GPP TS 23.273 v17.6.0 goes on: a default subscription as described in TS 23.271 clause 9.5.3.3 is included in the UE LCS privacy profile for any value added LCS client or AF not otherwise identified for the Call/Session unrelated Class and defines one of the following alternatives:
positioning not allowed (default case);
positioning allowed with notification to the UE user;
positioning requires notification and verification by the UE user; positioning is allowed only if granted by the UE user or if there is no response to the notification;
positioning requires notification and verification by the UE user; positioning is allowed only if granted by the UE user.

3GPP TS 23.273 v17.6.0, Clause 5.4.2.2.4—‘PLMN Operator Class’ states that the PLMN operator class defined in clause 9.5.3.4 of TS 23.271 is supported. NOTE: The PLMN Operator Class (except O&M LCS client in the VPLMN) can be applied to SNPN.

3GPP TS 23.273 v17.6.0, Clause 5.4.2.3—‘Location Privacy Indication (LPI)’ states that the Location Privacy Indication defines whether LCS requests for UE from any LCS clients are allowed or disallowed. The LPI at least includes one of the following global settings (for all LCS clients and AFs): Location for UE is disallowed (location for UE not allowed to any LCS client except where POI applies); and Location for UE is allowed (default setting, and LCS requests for UE from LCS clients are authorized based on their associated privacy classes as defined in clause 5.4.2.2). NOTE: Additional LPI values may be supported for additional differentiation of location request types. The LPI takes precedence on the subscribed privacy classes as defined in clause 5.4.2.2. The LPI allows a UE to override the location preference of the subscribed privacy classes. The usage of LPI is described in clause 6.1.2.

3GPP TS 23.273 v17.6.0, Clause 5.4.4—‘Privacy Override Indicator (POI)’ states that the POI is used to determine whether the UE LCS privacy profile of the subscriber to be positioned shall be overridden by the request for location services. The POI is applicable only to regulatory services. The assignment of a POI value with an “override” or “not override” value in the LCS client profile (see clause 7.2.1) is done during the LCS client provisioning (out of scope of this specification). The type of LCS client requesting location information (i.e. emergency, law-enforcement etc.) shall determine the value of the POI assigned to the LCS client profile.

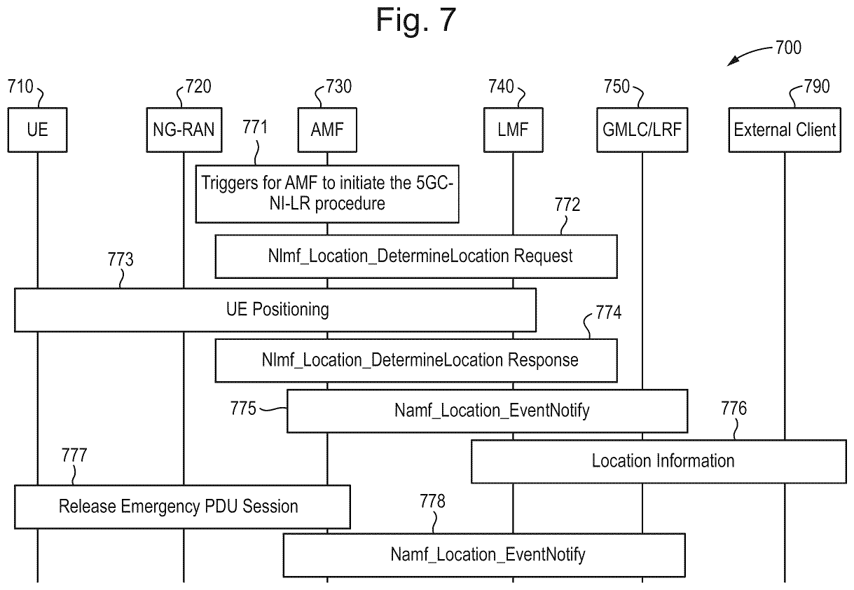

FIG. 7 illustrates 5GC Network Induced Location Request (5GC-NI-LR) for a UE. Such a process 700 is described at 3GPP TS 23.273 v17.6.0, Clause 6.10—‘Procedures dedicated to Support Regulatory services’, and Sub-Clause 6.10.1—‘5GC-NI-LR Procedure’. FIG. 7 shows a Network Induced Location Request (NI-LR) procedure for a UE in the case where the UE initiates an emergency session or other session using NG-RAN. The procedure 700 takes place between a UE 710, an NG-RAN 720, an AMF 730 an LMF 740 a GMLC/LRF 750 and an external client 790. The UE 710 may comprise a remote unit 102, a user equipment apparatus 200, or a UE 410, 810, 910 as described herein. The AMF 730 may comprise a network node 300, or an AMF 430, 530, 630, 830, 930 as described herein. The procedure 700 assumes that the serving AMF 730 is aware of the regulatory service associated with the session (e.g. emergency session initiation—e.g. due to supporting an Emergency Registration procedure or assisting in establishing an emergency PDU Session). The procedure can also be used to verify UE location for NR satellite access.

At 771, a trigger for AMF 730 to initiate the 5GC-NI-LR procedure happens, e.g. the UE registers to the 5GC for emergency services or requests the establishment of a PDU Session related to an applicable regulatory service (e.g., emergency session initiation) or the AMF decides to verify UE location via LCS service for a UE registering or is registered for NR satellite access.

At 772, for verifying UE location via LCS service for NR satellite access this step is mandatory, for other triggers the step is optional. The AMF selects an LMF based on NRF query or configuration in AMF and invokes the Nlmf_Location_DetermineLocation service operation towards the LMF to request the current location of the UE. The service operation includes a LCS Correlation identifier, the serving cell identity of the Primary Cell in the Master RAN node and the Primary Cell in the Secondary RAN node when available based on Dual Connectivity scenarios, and an indication of a location request from a regulatory services client (e.g., emergency services) and may include an indication if UE supports LPP, the required QoS and Supported GAD shapes, the UE Positioning Capability if available. When AMF needs to know the geographical area of the UE to check whether the PLMN is allowed to operate in the area, an indication of this is included. If any of the procedures in clause 6.11.1 or 6.11.2 are used the service operation includes the AMF identity.

At 773, if step 772 occurs, the LMF performs one or more of the positioning procedures described in clause 6.11.1, 6.11.2 and 6.11.3. If the AMF included an indication of UE country determination at step 772, the LMF maps the UE location to a geographical area where a PLMN is or is not allowed to operate.

At 774, if step 773 occurs, the LMF returns the Nlmf_Location_DetermineLocation Response towards the AMF to return the current location of the UE. The service operation includes the LCS Correlation identifier, the location estimate, its age and accuracy and may include information about the positioning method and the timestamp of the location estimate.

The service operation also includes the UE Positioning Capability if the UE Positioning Capability is received in step 773 including an indication that the capabilities are non-variable and not received from AMF in step 772. When UE geographical area determination for location verification is indicated at step 772, the service operation also returns the geographical area where a PLMN is or is not allowed to operate determined at step 773.

At 775, for emergency services, the AMF selects an GMLC based on NRF query or configuration in AMF. The information regarding the endpoint in the GMLC to deliver the event notification, is obtained from the NRF as specified in clause 7.1.2 of TS 23.501 or from local configuration in the AMF. AMF invokes the Namf_Location_EventNotify service operation towards the selected GMLC to notify the GMLC of an emergency session initiation. The service operation includes the SUPI or the PEI, and the GPSI if available, the identity of the AMF, an indication of an emergency session and any location obtained in step 773.

At 776, for emergency services, the GMLC forwards the location to an external emergency services client or may wait for a request for the location from the external emergency services client (not shown in FIG. 6.10.1-1) before forwarding the location.

At 777, for emergency services, the emergency services session and emergency PDU Session are released.

At 778, for emergency services, the AMF invokes the Namf_Location_Event-Notify service operation towards the GMLC to notify the GMLC that the emergency session was released to enable the GMLC and LRF to release any resources associated with the emergency session.

3GPP TR 33.896 v0.3.0 titled “Study of security aspects on user consent for 3GPP services phase 2” describes a Related Security Key Issue (with only key Issue and security threat) was agreed in TR 33.896.

A further Key Issue is that of User consent for NTN. An NTN scenario is specified in clause 5.4.11 of 3GPP TS 23.501v17.6.0 and clause 16.14 of 3GPP TS 38.300 v17.2.0. For this scenario, the NG-RAN in NTN may require UE's location information for selecting the AMF. Known systems operate by way of that after AS security is activated, the NG-RAN in NTN can request the UE to report its accurate location or coarse location. However, for both types of location reports obtaining, the user consent aspect is missing.

This key issue is intended to study whether there is any need to enhance the current user consent framework specified in Annex V in 3GPP TS 33.501 v17.6.0 in order to support the NTN feature.

If the NG-RAN in NTN is not aware of user consent status, then the NG-RAN in NTN may collect user's location information without consent which could lead to a compromise of the user privacy. Further, if the NG-RAN in NTN is not aware that user consent for NTN use case has been revoked, then the NG-RAN in NTN may continue to collect user's location information which could lead to a compromise of user privacy.

The arrangements described herein require that the 5GS shall provide the means to enable the NG-RAN to obtain the UE location for NTN based on granted user consent. Further, the 5GS shall provide the means for user consent revocation for NTN.

With regard to known systems such as described in TS 23.273 v17.6.0, it is noted that with subscription, privacy preferences for a UE are stored in a UE LCS privacy profile as part of UE subscription data in the UDM/UDR and queried from the UDM by another NF such as GMLC or NEF. The UE LCS privacy profile is used to indicate whether LCS requests from LCS clients and AFs are allowed or disallowed, together with the POI. But the existing UE LCS privacy profile does not provide any privacy related information to clarify the following:
if the gNB is ‘allowed or not allowed’ to request UE location data. (i.e., either from the UE or to use the LCS service).
if the AMF is ‘allowed or not allowed’ to request UE location data (i.e., either from the UE via NG-RAN (or) to use the LCS service).

Further apart from the UE LCS privacy profile managed in the UDM/UDR, the UDM/UDR also do manage any UE location information related privacy preferences/user consent for the NG-RAN and/or AMF specific to NTN service by considering the regulatory requirements (e.g., if UE location verification is required to meet regulatory requirement).

It is also noted that 5GC Network Induced Location Request determinations by AMF for satellite access (i.e., NTN service) related to UE location verification do not take into account user privacy preferences currently. If the User privacy preference (user consent) driven location verification is implemented, it can lead to more issues such as if location sharing grant is not provided by the UE (i.e., if the NG-RAN/AMF is not allowed to fetch UE location information), then skipping UE location verification can violate the regulatory requirements and the PLMN may be forced to provide satellite access based network service, in the location(s) which are not allowed by the regulation.

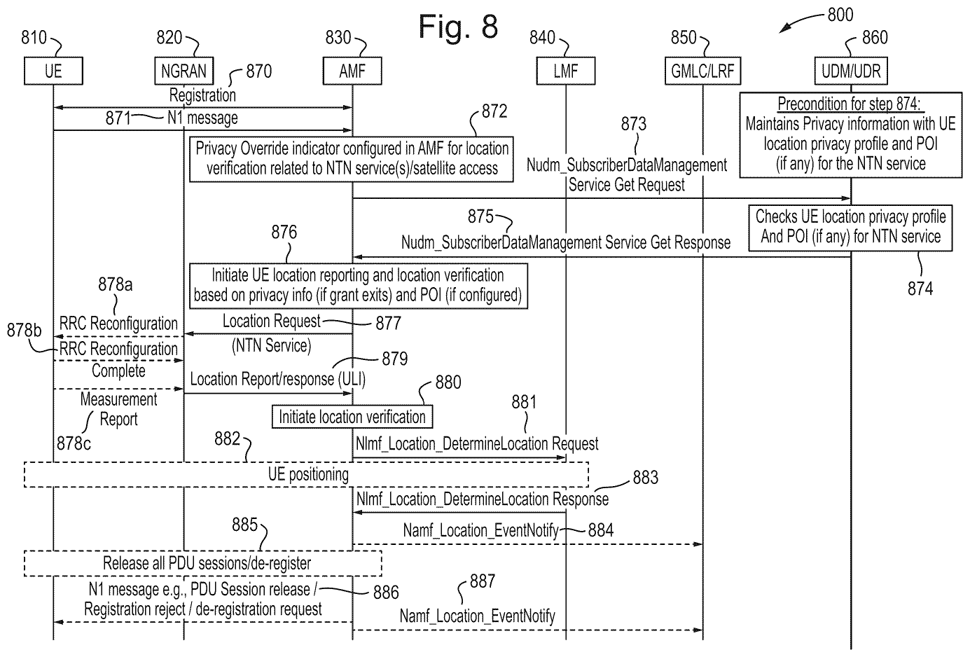

FIG. 8 illustrates a method 800 for accessing and verifying UE location based on privacy and regulatory enforcement information. User privacy information and the Privacy override indicator (POI) (if configured based on regulatory requirement) can be used by the AMF to determine if a location information for a UE can be requested from the NG-RAN or not (i.e., if the NG-RAN is allowed to fetch UE location information or not is determined based on the user privacy information fetched from the UDM and/or based on POI). The procedure to verify the user privacy before initiating a UE location request and/or UE location verification is shown in FIGS. 3.1-1. Further if the user privacy information do not allow location information collection by the NG-RAN, then the AMF either rejects any NAS request that was received over the satellite access or the AMF initiates UE deregistration. Alternatively, if the AMF is configured with a POI (or a POI if fetched from UDM), the AMF over-rides the UE privacy information (i.e., any location sharing even if not allowed), the AMF initiates UE location reporting from NG-RAN and then performs a UE location verification to check if the PLMN/the network is allowed to operate over satellite access in the UE's location.

The method 800 is performed by a UE 810, an NGRAN 820, An AMF 830, an LMF 840, a GMLC/LRF 850 and a UDM/UDR 860. The UE 810 may comprise a remote unit 102, a user equipment apparatus 200, or a UE 410, 710, 910 as described herein. The AMF 830 may comprise a network node 300, or an AMF 430, 530, 630, 730, 930 as described herein. The method 800 commences at step 870, where the UE 810 initiates a registration request with the network and successfully performs primary authentication. Alternatively, the method 800 may commence with the UE 810 already registered with the network.

At step 871, the UE 810 using satellite access may send over NAS, a N1 message (containing any of mobility registration update request or a SM message related to PDU session).

At step 872, the AMF 830 determines during the mobility management procedure or Session management procedure, that the AMF 830 needs to verify if the PLMN is allowed to operate satellite access in the UE location based on local configuration. In one implementation, the AMF 830 may be aware of the satellite access based on the RAT type indication, e.g., Terrestrial or NTN RAT type. The AMF 830 can be locally configured with a Privacy override indicator (POI) for the satellite access or NTN service based on the operator according to the regulatory requirements (e.g., this configuration can be applicable for a set of UEs/or for all UEs).

At step 873, for NG-RAN 820 based UE location reporting, based on local configuration the AMF 830 can determine to request UE location information from the NG-RAN 820 after checking the UE 810 related privacy Information and POI (if any exist for the UE NTN service/satellite access). This request may comprise NF ID, UE ID, NTN service, and/or Privacy Info check.

The AMF 830 sends a Nudm_SubscriberDataManagement Service Get Request to the UDM 860 which includes NF ID, UE ID (i.e., SUPI or GPSI), NTN Service type indication (or satellite access indication), and privacy information check required indication). It should be noted that in step 873, the UE ID is most likely to contain SUPI. Alternatively, a privacy information check required indication can be termed as ‘User consent information’ required indication.

A precondition for step 874 is that the UDM/UDR 860 maintains privacy information which includes UE location privacy profile, with NTN service/satellite access security type, location privacy indication: containing any of the following information such as ‘UE location sharing allowed/disallowed to NG-RAN’, ‘UE location sharing allowed/disallowed/not allowed to AMF’. The UDM/UDR 860 can also maintain the POI specific to the NTN service/satellite access based on regulatory requirements. However, alternatively, the UE location privacy profile may also include user consent information for the UE location sharing with NG-RAN 820 and AMF 830 as follows: User Consent granted/not granted for NG-RAN, User Consent granted/not granted for AMF, if granted is indicated, then a suitable time period for the validity of the user consent data for the NTN service/satellite access may also be stored.

The UDM 860 on receiving the message at step 873, fetches the UE location privacy profile related to SUPI for the NTN service/satellite access as indicated in the step 873 message. The UDM 860 may also fetch POI if exists for the NTN service/satellite access (e.g., from the subscription data).

At step 875, the UDM 860 sends to the AMF, Nudm_SubscriberDataManagement Service Get Response which includes UE ID, NTN service, the Privacy Information (i.e., UE location privacy profile and POI (if any)). Alternatively, privacy information sent in step 875 can be termed as ‘User consent information’.

At step 876, the AMF determines ‘if a UE location reporting can be requested from the NG-RAN or not’ based on the UE privacy information fetched from the UDM 860 and if any POI is locally configured (and/or fetched from the UDM 860).

If the UE privacy information fetched from the UDM 860 indicates that ‘UE location sharing is allowed to NG-RAN’ and/or ‘UE location sharing is allowed to AMF’ or contains a POI, the AMF determines to request UE location information (ULI) from the NG-RAN by performing step 877.

If the UE privacy information fetched from the UDM 860 indicates that ‘UE location sharing is ‘not allowed/disallowed’ to NG-RAN’ and/or ‘UE location sharing is not allowed/disallowed to AMF’, the AMF 830 determines not to request UE location information (ULI) from the NG-RAN 820 and determines to reject any NAS request/deregister the UE 810, in this case the AMF 830 then continues with step 885.

If a POI is configured in the AMF 830 (or a POI is fetched from the UDM 860), the POI may take higher precedence/priority over the UE privacy information fetched from the UDM 860. Based on POI (i.e., configured based on regulatory requirements), the AMF 830 can determine to override the UE privacy information (even if the user consent is set as ‘not granted’ for the UE location sharing to NG-RAN/AMF (or) UE location sharing is disallowed/not allowed to AMF′) and determines to perform step 877.

It should be noted that POI may be coupled with NI-LR procedures, where in addition to the regulatory services, the POI may be configured for location verification procedure. For example, if an NTN verification procedure is initiated by AMF, the POI would override the privacy profile of the target user and directly initiate the location verification procedure.

At step 877, the AMF 830 can send a location request to NG-RAN 820 in a N2 message (e.g., using a Location Reporting Control message or in any N2 Notification Request) with includes NTN service or satellite access indication.

At step 878a, the NG-RAN 820, if it has received any ‘NTN service/satellite access indication’, the NG-RAN 820 may initiate a RRC reconfiguration procedure to collect a suitable measurement report (specific to Satellite access/NTN service to identify the correct UE location information). The NG-RAN 820 sends RRC Reconfiguration message 878a to the UE 810 which includes the measurement configuration for NTN cells, e.g., including any positioning-related measurements. The measurement configuration also contains a request that the UE 810 provides UE location information (e.g., for NTN service or Satellite access with a related indication).

At step 878b, the UE 810 sends RRC Reconfiguration complete message upon successful reception of the RRC Reconfiguration message.

At step 878c, the UE 810 performs measurements in accordance with the configuration received in step 878a and sends the measurement report and UE location information via Measurement Report message to the NG-RAN 820.

At step 879, the NG-RAN 820 sends the UE location information (e.g., Cell ID(s), TAI(s), or any other RAT-independent location estimates, e.g., GNSS based location estimate, Bluetooth, WLAN, etc.) to the AMF 830 in a N2 message.

At step 880, the AMF 830 determines to initiate UE location verification based on local configuration (e.g., based on regulatory requirement). A trigger for AMF 830 to initiate the 5GC-NI-LR procedure happens, e.g., the UE 810 registers to the 5GC for emergency services or requests the establishment of a PDU Session related to an applicable regulatory service (e.g., emergency session initiation) or the AMF 830 decides to verify UE location via LCS service for a UE registering or is registered for NR satellite access.

It should be noted that the POI may be coupled with NI-LR procedures, where, in addition to the regulatory services, the POI may be configured for location verification procedure. For example, if an NTN verification procedure is initiated by AMF 830, the POI would override the privacy profile of the target user and directly initiate the location verification procedure.

At step 881, for verifying UE location via LCS service for NR satellite access this step is mandatory, for other triggers the step is optional. The AMF 830 selects an LMF 840 based on NRF query or configuration in AMF 830 and invokes the Nlmf_Location_DetermineLocation service operation towards the LMF 840 to request the current location of the UE 810. The service operation includes a LCS Correlation identifier, the serving cell identity of the Primary Cell in the Master RAN node and the Primary Cell in the Secondary RAN node when available based on Dual Connectivity scenarios, and an indication of a location request from a regulatory services client (e.g., emergency services) and may include an indication if UE supports LPP, the required QoS and Supported GAD shapes, the UE Positioning Capability if available. When AMF 830 needs to know the geographical area of the UE 810 to check whether the PLMN is allowed to operate in the area, an indication of this is included. If any of the procedures in ‘UE Assisted and UE Based Positioning Procedure’ or ‘Network Assisted Positioning Procedure’ are used, the service operation includes the AMF identity.

At step 882, if step 881 occurs, the LMF 840 performs one or more of the positioning procedures described in ‘UE Assisted and UE Based Positioning Procedure’, ‘Network Assisted Positioning Procedure’ and ‘Obtaining Non-UE Associated Network Assistance Data’. If the AMF 830 included an indication of UE country determination at step 881, the LMF 840 maps the UE location to a geographical area where a PLMN is or is not allowed to operate.

At step 883, if step 882 occurs, the LMF 840 returns the Nlmf_Location_DetermineLocation Response towards the AMF 830 to return the current location of the UE. The service operation includes the LCS Correlation identifier, the location estimate, its age and accuracy and may include information about the positioning method and the timestamp of the location estimate. The service operation also includes the UE Positioning Capability if the UE Positioning Capability is received in step 873 including an indication that the capabilities are non-variable and not received from AMF 830 in step 872. When UE geographical area determination for location verification is indicated at step 882, the service operation also returns the geographical area where a PLMN is or is not allowed to operate determined at step 883. Any remaining procedures for regulatory services other than emergency services may be applied but are not described here. The following steps may be applicable for emergency services and satellite services.

At step 884, for emergency services/satellite access/NTN services, the AMF 830 selects a GMLC based on NRF query or configuration in AMF 830. The information regarding the endpoint in the GMLC to deliver the event notification, is obtained from the NRF or from local configuration in the AMF 830. AMF 830 invokes the Namf_Location_EventNotify service operation towards the selected GMLC to notify the GMLC 850 of an emergency session initiation/NTNserviceinitiation. The service operation includes the SUPI or the PEI, and the GPSI if available, the identity of the AMF 830, an indication of an emergency session/NTN service and any location obtained in step 883.

At step 885, for emergency services/satellite access/NTN services, the emergency services session/satellite access/NTN services related session and emergency PDU Session/satellite access/NTN associated PDU session are released.

The AMF 830, following the UE location verification result being “PLMN is not allowed to operate satellite access or NTN service in the UE location” as described in step 883 (or) if the AMF 830 finds the UE privacy information doesn't allow UE location sharing with NG-RAN/AMF (the AMF may determine based on local configuration that UE location verification is not possible without UE location information being shared to NG-RAN/AMF), then the AMF 830 may initiate to release all PDU sessions and deregistration of the UE 810.

At step 886, the AMF 830 sends to UE 810 (in any NI/NAS message) a PDU Session release/Registration reject/de-registration request with a suitable cause value indicating to Location verification failure/location information access not available for NTN service/satellite access. This message may comprise Location verification failure/location information access not available for NTN service/satellite access.

At step 887, for emergency services/satellite access/NTN services, the AMF 830 invokes the Namf_Location_EventNotify service operation towards the GMLC 850 to notify the GMLC 850 that the emergency session was released to enable the GMLC and LRF 850 to release any resources associated with the emergency session/satellite access/NTN services.

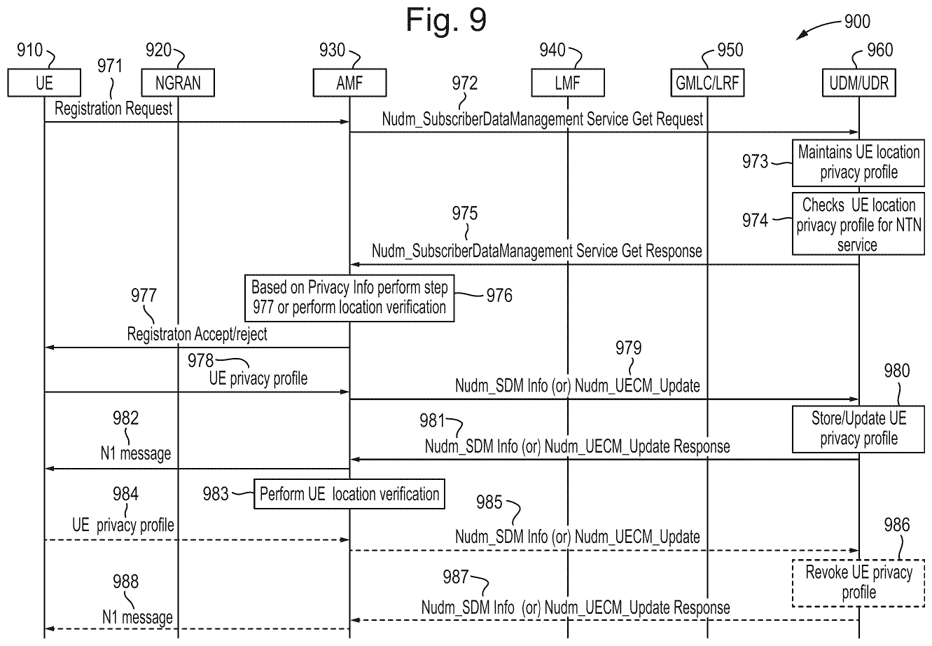

FIG. 9 illustrates a method 900 for managing UE privacy information collection and revocation for location sharing related to satellite access/NTN Service. For the UE accessing the network (i.e., PLMN) using satellite access/NTN service, embodiment 2 describes how a UE privacy information (if not available or indicates that UE location sharing is ‘not granted/not allowed’), is requested to provide ‘user consent/grant’ for location sharing to enable UE location reporting from NG-RAN and UE location verification by the AMF. Further Embodiment 2 also describes, how a UE privacy information for location sharing related to satellite access/NTN service is fetched from the UE and managed (i.e., stored and updated for user consent grant provision and user consent grant revocation) in the UDM/UDR by the AMF.

The method 900 is performed by a UE 910, an NGRAN 920, An AMF 930, an LMF 940, a GMLC/LRF 950 and a UDM/UDR 960. The UE 910 may comprise a remote unit 102, a user equipment apparatus 200, or a UE 410, 710, 810 as described herein. The AMF 930 may comprise a network node 300, or an AMF 430, 530, 630, 730, 830 as described herein. The method 900 commences at step 971, the UE 910 (accessing the network using satellite access) sends the registration request which includes NTN service/Satellite access indication.

At step 972, the AMF 930 if locally configured to perform UE location verification for regulatory requirement, based on local configuration the AMF 930 can determine to request UE location information from the NG-RAN 920 after checking the UE related privacy Information. The get request may comprise NF ID, UE ID, NTN service, and/or Privacy Info check.

The AMF 930 sends a Nudm_SubscriberDataManagement Service Get Request to the UDM 960 which includes NF ID, UE ID, (SUPI), NTN Service type indication (or satellite access indication), and privacy information check required indication). Alternatively, privacy information check required indication can be termed as ‘User consent information’ required indication.

At step 973, which may be considered a precondition, the UDM/UDR 960 maintains UE location privacy profile, with NTN service/satellite access security type, location privacy indication: containing any of the following information such as ‘UE location sharing allowed/disallowed to NG-RAN’, ‘UE location sharing allowed/disallowed/not allowed to AMF’. The privacy profile may comprise an NTN service indication and/or a Location privacy Indication comprising location sharing to NG-RAN Allowed/Disallowed, location sharing to AMF Allowed/Disallowed.

Alternatively, the UE location privacy profile may also include user consent information for the UE location sharing with NG-RAN and AMF as follows: User Consent granted/not granted for NG-RAN, User Consent granted/not granted for AMF, if granted is indicated, then a suitable time-period for the validity of the user consent data for the NTN service/satellite access may also be stored.

At step 974, the UDM 960 on receiving the message in step 972, fetches the UE location privacy profile related to SUPI for the NTN service/satellite access as indicated in the message of step 972.

At step 975, the UDM 960 sends to the AMF 930, Nudm_SubscriberData-Management Service Get Response which includes UE ID, NTN service, and the Privacy Information (i.e., UE location privacy profile). Alternatively, privacy information sent in step 975 can be termed as ‘User consent information’.

At step 976, the AMF 930 determines ‘if a UE location reporting can be requested from the NG-RAN or not’ based on the UE privacy information fetched from the UDM 960.

If the UE privacy information fetched from the UDM 960 indicates that ‘UE location sharing is allowed to NG-RAN’ and/or ‘UE location sharing is allowed to AMF’, the AMF 930 determines to request UE location information (ULI) from the NG-RAN by performing step 877 (as described in connection with FIG. 8) and continues with steps 877-887 as shown in FIG. 8.

If the UE privacy information fetched from the UDM 960 indicates that ‘UE location sharing is ‘not allowed/disallowed’ to NG-RAN’ and/or ‘UE location sharing is not allowed/disallowed to AMF’, the AMF 930 determines not to request UE location information (ULI) from the NG-RAN 920 and determines to accept or reject the registration request from the UE 910, in this case the AMF 930 performs step 977 below.

At step 977, the AMF 930 sends a registration accept message which includes, ‘a require location permission for NTN service/satellite access indication’ (or) ‘location permission for NTN service/satellite access required indication’. Alternatively, the AMF 930 sends a registration reject message which includes, ‘a require location permission for NTN service/satellite access indication’ (or) ‘location permission for NTN service/satellite access required indication’. In this case, the UE 910 may need to register to the PLMN over terrestrial access and need to perform UE initiated UE privacy profile update procedure, steps 978 to 982 and then the UE 910 can again perform registration update via satellite access.

At step 978, the UE 910 generates and sends UE privacy profile along with SUPI to the AMF 930 using an N1 message (i.e., over NAS transport). Wherein the UE privacy profile includes UE privacy profile update indication, service type set to NTN service/satellite access, UE location sharing granted indication per NG-RAN and AMF, validity associated to the location sharing grant. The UE privacy profile may comprise ant combination of a UE privacy profile update indication, an NTN service/Satellite Access, a UE Location Sharing Granted (NG-RAN, AMF), and/or validity. Alternatively, UE privacy profile update indication can be termed as user consent update indication. Alternatively, Wherein the UE privacy profile includes UE privacy profile update indication, service type set to NTN service/satellite access, UE data set to ‘UE location sharing’, user consent sent to ‘granted indication per NG-RAN 920 and AMF 930, validity associated to the location sharing grant.

At step 979, the AMF 930, on receiving the UE privacy profile, sends to the UDM/UDR 960 the UE privacy profile (received in step 978) along with NF ID and UE ID (i.e., SUPI) in a Nudm service operation message (e.g., Nudm_SDM Info or Nudm_UECM_Update message). The message may comprise any combination of NF ID, UE ID, UE privacy profile (UE privacy profile update indication, NTN service/Satellite Access, UE Location Sharing Granted (NG-RAN, AMF), and/or validity.

At step 980, the UDM 960 stores and updates the received UE privacy profile for the UE related to SUPI along with the subscription information.

At step 981, the UDM 960 sends a response message to the AMF 930 which includes UE ID (SUPI) and UE privacy profile update successful indication. The response message may comprise any combination of UE ID, UE privacy profile update successful.

At step 982, the AMF 930 sends to UE 910 over the N1 message/NAS transport, the UE privacy profile update successful indication. The N1 message may comprise an indication that the UE privacy profile update was successful.

At step 983, the AMF 930 can perform UE location request via NG-RAN 920 and performs UE location verification similar to the method illustrated in FIG. 8 and steps 877-887 thereof.

At step 984, the UE 910 at any time (based on upper layer trigger e.g., based on user settings, i.e., if the user changes from time to time its privacy profile in the UE 910) can generate and send UE privacy profile along with SUPI to the AMF 930 over the N1 messages (i.e., over NAS transport). Wherein the UE privacy profile includes UE privacy profile update/revoke indication, service type set to NTN service/satellite access, UE location sharing not granted/grant revoked indication per NG-RAN and AMF, validity associated to the location sharing grant. The UE privacy profile may comprise ant combination of a UE privacy profile update indication, an NTN service/Satellite Access, a UE Location Sharing Granted (NG-RAN, AMF), and/or validity.

Alternatively, UE privacy profile update indication can be termed as user consent revoke indication. Alternatively still, where the UE privacy profile may include UE privacy profile update/revoke indication, service type set to NTN service/satellite access, UE data set to ‘UE location sharing’, user consent sent to ‘revoked/not granted indication per NG-RAN 920 and AMF 930, validity associated to the location sharing grant.

At step 985, the AMF on receiving the UE privacy profile, the AMF 930 sends to the UDM/UDR 960 the UE privacy profile (received in step 984) along with NF ID and UE ID (i.e., SUPI) in a Nudm service operation message (e.g., Nudm_SDM Info or Nudm_UECM_Update message). The message may comprise any combination of NF ID, UE ID, UE privacy profile (UE privacy profile update indication, NTN service/Satellite Access, UE Location Sharing Granted (NG-RAN, AMF), and/or validity.

At step 986, the UDM 960 revokes and updates the locally stored UE privacy profile based on the received UE privacy profile for the UE stored related to SUPI along with the subscription information.

At step 987, the UDM 960 sends a response message to the AMF 930 which includes UE ID (SUPI) and UE privacy profile update/revocation successful indication.

At step 988, the AMF 930 sends to UE 910 over the N1 message/NAS transport, the UE privacy profile update/revocation successful indication.

There is provided an apparatus comprising a transceiver; and a processor coupled to the transceiver. The processor and the transceiver configured to cause the apparatus to: receive an N1 message from a user equipment “UE” over a Non-Terrestrial Network “NTN” service; send a get request to a UDM which includes UE ID, NTN service type and an indication for a privacy information check; receive a get response from the UDM with UE ID, NTN service type, and privacy information; and responding to the N1 message based on the received privacy information.

The apparatus may be an AMF. The Non-Terrestrial Network service may comprise satellite access. The N1 message may be a Non-Access-Stratum (NAS) message. The N1 message may be a first N1 message. Subsequent communication between the UE and the apparatus may be conducted using further N1 messages. The privacy information may relate to the UE. The privacy information may comprise one or more of: UE privacy information and a Privacy Override Indicator (POI). The apparatus may include a Privacy Override Indicator (POI) configured for the NTN service.

For a UE using NR satellite access, an AMF may request and receives UE location related data from NG-RAN and performs UE location verification to determine if the PLMN is allowed to operate at the present UE location to meet regulatory requirements that apply. If the AMF finds that it is not allowed to operate at the UE location, the AMF may either reject any NAS request or if the UE is already registered, the AMF initiates a de-registration for the UE. For NTN services/satellite access, UE location data collection by the NG-RAN and/or AMF requires User consent to be granted by the UE such that if a user consent is not granted, then the AMF cannot verify the UE location. Should an AMF in the PLMN allow a UE to have satellite access without verifying the location of the UE, then the AMF may violate the regulatory requirements. The apparatus described herein tends to prevent such regulatory violation by responding to an N1 message such as a registration request based on privacy information retrieved from a UDM.

UE location may comprise Cell ID, Tracking Area identity (TAI), Global Navigation Satellite System (GNSS) co-ordinations, or other positioning information. Responding to the N1 message based on the received privacy information may comprise determining to perform a UE location request. Responding to the N1 message based on the received privacy information may comprise performing a UE location request.

Responding to the N1 message based on the received privacy information may comprise performing a UE location request from an NG-RAN if the privacy information indicates location sharing is allowed for the NG-RAN. Alternatively, the apparatus may not perform the UE location request if the privacy information indicates location sharing is not allowed for the NG-RAN.

Responding to the N1 message based on the received privacy information may comprise performing a UE location request from an NG-RAN if the privacy information indicates a Privacy Override Indicator “POI” for the NTN service. A POI for the NTN service may be a POI that is relevant to the NTN service. A POI for the NTN service may comprise a POI including an identity of the NTN service.

The received privacy information may comprise a Privacy Override Indicator “POI”, and wherein responding to the N1 message based on the received privacy information may comprise performing a UE location request from an NG-RAN if the POI is configured in the apparatus for the NTN service. A POI for the NTN service may be a POI that is relevant to the NTN service. A POI for the NTN service may comprise a POI including an identity of the NTN service.

Responding to the N1 message based on the received privacy information may comprise performing a UE location verification if the UE privacy indicates location sharing as allowed for the NG-RAN and/or the apparatus. Alternatively, the apparatus may determine not to perform UE location verification if the UE privacy indicates location sharing as not-allowed for NG-RAN and/or the apparatus.

Responding to the N1 message based on the received privacy information may comprise sending a registration accept message which includes an indication that location permission is required for access to the NTN service.

Responding to the N1 message based on the received privacy information may comprise sending a registration reject message which includes an indication that location permission is required for access to the NTN service.

Responding to the N1 message based on the received privacy information may comprise rejecting the N1 message if the privacy information indicates location sharing is not-allowed for NG-RAN and/or the apparatus.

Responding to the N1 message based on the received privacy information may comprise deregistering the UE if the privacy information indicates location sharing as not-allowed for NG-RAN and/or the apparatus.

The apparatus may be further arranged to send, in response to the N1 message, a registration reject message. The registration reject message may be sent with any of: a Location verification failure; a location information access not available for NTN service indication; and a location information access not available for satellite access indication.

The apparatus may be further arranged to receive from the UE a UE privacy profile and a UE ID. The UE ID may be SUPI.

The apparatus may be further arranged to send to the UDM the UE privacy profile, NF ID and UE ID in a Nudm service operation message.

In response to the UE privacy profile, NF ID and UE ID sent to the UDM in a Nudm service operation message, the UDM may update a UE privacy profile stored at the UDM and the apparatus may be further arranged to receive a response message from the UDM which includes UE ID and UE privacy profile update successful indication.

The profile update may comprise a profile revocation.

The apparatus may be further arranged to send to the UE the UE privacy profile update successful indication. The profile update may comprise a profile revocation. The UE privacy profile update successful indication may be sent to the UE by the apparatus in a further N1 message. The UE privacy profile update successful indication may be sent to the UE by the apparatus using NAS transport.

The privacy information may comprise one or more of: NTN service type; satellite access security type; a location privacy indication and a POI (e.g., configured by the network for NTN service). The location privacy indication may contain any of: UE location sharing allowed to NG-RAN; UE location sharing not allowed to NG-RAN; UE location sharing allowed to AMF; and UE location sharing not allowed to AMF.

The apparatus may be further arranged to receive a Privacy override indicator (POI) for the NTN service. The POI may be dependent on the operator of the NTN service. The POI may be dependent upon regulatory requirements applicable to the NTN service and/or the terrestrial wireless communication network. The POI may be applicable for a specific UE, a set of UEs and/or for all UEs.

A Privacy Override Indicator (POI) may be configured at the apparatus, and the POI may take higher precedence over the privacy information. The NI message received from the UE may be a registration request, and the registration request may include an indication of the NTN service.

The UDM may be arranged to maintain one or more of: a UE location privacy profile and a POI (for NTN service). The UE location privacy profile may comprise an NTN service indication and/or a Location privacy Indication. The Location privacy Indication may comprise any of: location sharing to NG-RAN Allowed/Disallowed, location sharing to AMF Allowed/Disallowed.

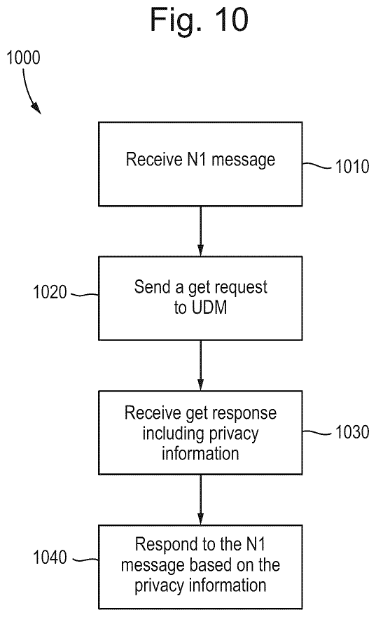

FIG. 10 illustrates a method 1000 comprising: receiving 1010 an N1 message from a user equipment “UE” over a Non-Terrestrial Network “NTN” service; sending 1020 a get request to a UDM which includes UE ID, NTN service type and an indication for a privacy information check; receiving 1030 a get response from the UDM with UE ID, NTN service type, and privacy information; and responding 1040 to the N1 message based on the received privacy information.

Responding 1040 to the N1 message based on the received privacy information may comprise responding to the N1 message based on the received privacy information and a Privacy Override Indicator (POI). Responding 1040 to the N1 message based on the received privacy information may comprise responding to the N1 message based on the received privacy information and a Privacy Override Indicator (POI) if a POI is configured locally.

In certain embodiments, the method 1000 may be performed by a processor executing program code, for example, a microcontroller, a microprocessor, a CPU, a GPU, an auxiliary processing unit, a FPGA, or the like.

The method may be performed by an apparatus. The apparatus may be an AMF. The Non-Terrestrial Network service may comprise satellite access. The N1 message may be a Non-Access-Stratum (NAS) message. The N1 message may be a first N1 message. Subsequent communication between the UE and the apparatus may be conducted using further N1 messages. The privacy information may relate to the UE. The privacy information may comprise one or more of: UE privacy information and a Privacy Override Indicator (POI). The apparatus may include a Privacy Override Indicator (POI) configured for the NTN service.

For a UE using NR satellite access, an AMF may request and receives UE location related data from NG-RAN and performs UE location verification to determine if the PLMN is allowed to operate at the present UE location to meet regulatory requirements that apply. If the AMF finds that it is not allowed to operate at the UE location, the AMF may either reject any NAS request or if the UE is already registered, the AMF initiates a de-registration for the UE. For NTN services/satellite access, UE location data collection by the NG-RAN and/or AMF requires User consent to be granted by the UE such that if a user consent is not granted, then the AMF cannot verify the UE location. Should an AMF in the PLMN allow a UE to have satellite access without verifying the location of the UE, then the AMF may violate the regulatory requirements. The methods described herein tend to prevent such regulatory violation by responding to an N1 message such as a registration request based on privacy information retrieved from a UDM.

UE location may comprise Cell ID, Tracking Area identity (TAI), Global Navigation Satellite System (GNSS) co-ordinations, or other positioning information.

Responding to the N1 message based on the received privacy information may comprise determining to perform a UE location request. Responding to the N1 message based on the received privacy information may comprise performing a UE location request.

Responding to the N1 message based on the received privacy information may comprise performing a UE location request from an NG-RAN if the privacy information indicates location sharing is allowed for the NG-RAN.

Alternatively, the method may comprise not performing the UE location request if the privacy information indicates location sharing is not allowed for the NG-RAN.

Responding to the N1 message based on the received privacy information may comprise performing a UE location request from an NG-RAN if the privacy information indicates a Privacy Override Indicator “POI” for the NTN service.

A POI for the NTN service may be a POI that is relevant to the NTN service. A POI for the NTN service may comprise a POI including an identity of the NTN service.

The received privacy information may comprise a Privacy Override Indicator “POI”, and responding to the N1 message based on the received privacy information may comprise performing a UE location request from an NG-RAN if the POI is configured for the NTN service.

A POI for the NTN service may be a POI that is relevant to the NTN service. A POI for the NTN service may comprise a POI including an identity of the NTN service.

Responding to the N1 message based on the received privacy information may comprise performing a UE location verification if the UE privacy indicates location sharing as allowed for the NG-RAN and/or the apparatus. Alternatively, the method may comprise determining not to perform UE location verification if the UE privacy indicates location sharing as not-allowed for NG-RAN and/or the apparatus.

Responding to the N1 message based on the received privacy information may comprise sending a registration accept message which includes an indication that location permission is required for access to the NTN service.

Responding to the N1 message based on the received privacy information may comprise sending a registration reject message which includes an indication that location permission is required for access to the NTN service.

Responding to the N1 message based on the received privacy information may comprise rejecting the N1 message if the privacy information indicates location sharing is not-allowed for NG-RAN and/or the apparatus.

Responding to the N1 message based on the received privacy information may comprise deregistering the UE if the privacy information indicates location sharing as not-allowed for NG-RAN and/or the apparatus.

The method may further comprise sending, in response to the N1 message, a registration reject message. The registration reject message may be sent with any of: a Location verification failure; a location information access not available for NTN service indication; and a location information access not available for satellite access indication.

The method may further comprise receiving from the UE a UE privacy profile and a UE ID. The UE ID may be SUPI.

The method may further comprise sending to the UDM the UE privacy profile, NF ID and UE ID in a Nudm service operation message.

In response to the UE privacy profile, NF ID and UE ID may be sent to the UDM in a Nudm service operation message, the UDM may then update a UE privacy profile stored at the UDM and the method may further comprise receiving a response message from the UDM which includes UE ID and UE privacy profile update successful indication. The profile update may comprise a profile revocation.

The method may further comprise sending to the UE the UE privacy profile update successful indication. The profile update may comprise a profile revocation. The UE privacy profile update successful indication may be sent to the UE in a further N1 message. The UE privacy profile update successful indication may be sent to the UE using NAS transport.

The privacy information may comprise one or more of: NTN service type; satellite access security type; a location privacy indication and a POI (e.g., configured by the network for NTN service). The location privacy indication may contain any of: UE location sharing allowed to NG-RAN; UE location sharing not allowed to NG-RAN; UE location sharing allowed to AMF; and UE location sharing not allowed to AMF.

The method may further comprise receiving a Privacy override indicator (POI) for the NTN service. The POI may be dependent on the operator of the NTN service. The POI may be dependent upon regulatory requirements applicable to the NTN service and/or the terrestrial wireless communication network. The POI may be applicable for a specific UE, a set of UEs and/or for all UEs.

A Privacy Override Indicator (POI) may be configured, and the POI may take higher precedence over the privacy information. The N1 message received from the UE may be a registration request, and the registration request may include an indication of the NTN service.

The UDM may be arranged to maintain one or more of: a UE location privacy profile and a POI (for NTN service). The UE location privacy profile may comprise an NTN service indication and/or a Location privacy Indication. The Location privacy Indication may comprise any of: location sharing to NG-RAN Allowed/Disallowed, location sharing to AMF Allowed/Disallowed.

Accordingly, there is provided an apparatus comprising: a transceiver; and a processor coupled to the transceiver, the processor and the transceiver configured to cause the apparatus to: receive a NAS message over a satellite access or using NTN service; send a get request to UDM which includes UE ID, NTN service type and privacy info check indication; receive a get response from UDM with UE ID, NTN service type, Privacy information; determine to perform UE location request based on any of: Privacy override indicator (POI) or UE privacy Information.

The UE privacy information may comprise one or more of: NTN service/satellite access security type, location privacy indication: containing any of the following information such as ‘UE location sharing allowed/not allowed to NG-RAN’, ‘UE location sharing allowed/not allowed to AMF’.

The POI may be configured in the AMF based on regulatory requirement, to over-ride the UE privacy information and POI takes higher precedence over the UE privacy information.

The AMF may perform UE location request from NG-RAN if the UE privacy indicates location sharing as allowed for NG-RAN.

The AMF may determine not to perform UE location request with NG-RAN if the UE privacy indicates location sharing as not-allowed for NG-RAN.

The AMF may perform UE location verification if the UE privacy indicates location sharing as allowed for NG-RAN and/or AMF.

The AMF may determine not to perform UE location verification if the UE privacy indicates location sharing as not-allowed for NG-RAN and/or AMF.

The AMF may determine to reject any NAS request if the UE privacy indicates location sharing as not-allowed for NG-RAN and/or AMF.

The AMF may determine to deregister UE if the UE privacy indicates location sharing as not-allowed for NG-RAN and/or AMF.

The AMF may send a registration reject message with any of: Location verification failure/location information access not available for NTN service/satellite access indication.

The AMF may send a de-registration request message with any of: Location verification failure/location information access not available for NTN service/satellite access indication.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: 5GC, 5G Core Network; 5GS, 5G System; 5G-AN, 5G Access Network; 5G-GUTI, 5G Globally Unique Temporary Identifier; 5G-S-TMSI, 5G S-Temporary Mobile Subscription Identifier; AF, Application Function; AMF, Access and Mobility Management Function; AS, Access Stratum; AUSF, Authentication Server Function; CAPIF, Common API Framework for 3GPP northbound APIs; CP, Control Plane; DL, Downlink; DN, Data Network; GEO, Geostationary Orbit; GMLC, Gateway Mobile Location Centre; GPSI, Generic Public Subscription Identifier; GUAMI, Globally Unique AMF Identifier; HGMLC, Home GMLC; HR, Home Routed (roaming); LEO, Low Earth Orbit; LMF, Location Management Function; LPP, LTE Positioning Protocol; LRF, Location Retrieval Function; LCS, LoCation Services; LDR, Location Deferred Request; LPI, LCS Privacy Indicator; MEO, Medium Earth Orbit; MICO, Mobile Initiated Connection Only; MO-LR, Mobile Originated Location Request; MT-LR, Mobile Terminated Location Request; NI-LR, Network Induced Location Request; NAI, Network Access Identifier; NEF, Network Exposure Function; NF, Network Function; NGAP, Next Generation Application Protocol; NID, Network identifier; NPN, Non-Public Network; NR, New Radio; NRF, Network Repository Function; NSSAI, Network Slice Selection Assistance Information; NTN, Non-Terrestrial Network; POI, Privacy override indicator; PCF, Policy Control Function; PDU, Protocol Data Unit; PEI, Permanent Equipment Identifier; (R)AN, (Radio) Access Network; SA NR, Standalone New Radio; SBA, Service Based Architecture; SBI, Service Based Interface; SEAF, Security Anchor Functionality; SMF, Session Management Function; SMSF, Short Message Service Function; SNPN, Stand-alone Non-Public Network; S-NSSAI, Single Network Slice Selection Assistance Information; SUCI, Subscription Concealed Identifier; SUPI, Subscription Permanent Identifier; TA, Tracking Area; TAI, Tracking Area Identity; UE, User Equipment; UDM, Unified Data Management; UDR, Unified Data Repository; UDSF, Unstructured Data Storage Function; UL, Uplink; UL CL, Uplink Classifier; and UPF, User Plane Function.

1. An apparatus for wireless communication, comprising:
at least one memory; and
at least one processor coupled with the at least one memory and configured to cause the apparatus to:
receive an N1 message from a user equipment (UE) over a Non-Terrestrial Network (NTN) service;
send a request to a unified data management (UDM) which includes a UE identifier (ID), an NTN service type, and an indication for a privacy information check;
receive a response from the UDM with the UE ID, the NTN service type, and privacy information; and
respond to the N1 message based on the received privacy information.

2. The apparatus of claim 1, wherein, to respond to the N1 message based on the received privacy information, the at least one processor is configured to cause the apparatus to determine to perform a UE location request.

3. The apparatus of claim 1, wherein, to respond to the N1 message based on the received privacy information, the at least one processor is configured to cause the apparatus to perform a UE location request a if the received privacy information indicates location sharing is allowed for the NG-RAN.

4. The apparatus of claim 1, wherein, to respond to the N1 message based on the received privacy information, the at least one processor is configured to cause the apparatus to perform a UE location request if the received privacy information indicates a Privacy Override Indicator (POI) for the NTN service.

5. The apparatus of claim 1, wherein the received privacy information comprises a Privacy Override Indicator (POI), and wherein, to respond to the N1 message based on the received privacy information, the at least one processor is configured to cause the apparatus to perform a UE location request if the POI is configured in the apparatus for the NTN service.

6. The apparatus of claim 1, wherein, to respond to the N1 message based on the received privacy information, the at least one processor is configured to cause the apparatus to perform a UE location verification if the received privacy information indicates that location sharing is allowed for a next generation radio access node (NG-RAN) or the apparatus.

7. The apparatus of claim 1, wherein, to respond to the N1 message based on the received privacy information, the at least one processor is configured to cause the apparatus to send a registration accept message that includes an indication that location permission is required for access to the NTN service.

8. The apparatus of claim 1, wherein, to respond to the N1 message based on the received privacy information, the at least one processor is configured to cause the apparatus to send a registration reject message that includes an indication that location permission is required for access to the NTN service.

9. The apparatus of claim 1, wherein, to respond to the N1 message based on the received privacy information, the at least one processor is configured to cause the apparatus to reject the N1 message if the received privacy information indicates location sharing is not allowed for a next generation radio access node (NG-RAN) or the apparatus.

10. The apparatus of claim 1, wherein, to respond to the N1 message based on the received privacy information, the at least one processor is configured to deregister the UE if the privacy information indicates location sharing is not allowed for a next generation radio access node (NG-RAN) or the apparatus.

11. The apparatus of claim 9, wherein the at least one processor is further configured to cause the apparatus to send, in response to the N1 message, a registration reject message.

12. The apparatus of claim 1, wherein the at least one processor is further configured to cause the apparatus to receive a UE privacy profile and the UE ID.

13. The apparatus of claim 12, wherein the at least one processor is further configured to cause the apparatus to send to the UDM the UE privacy profile, network function (NF) ID, and the UE ID.

14. The apparatus of claim 13, wherein the at least one processor is further configured to cause the apparatus to receive a response message from the UDM that includes the UE ID and a UE privacy profile update indication.

15. The apparatus of claim 14, wherein the at least one processor is further configured to cause the apparatus to send to the UE the UE privacy profile update indication.

16. The apparatus of claim 1, wherein the privacy information comprises one or more of: the NTN service type; a satellite access security type; a location privacy indication, and a Privacy Override Indicator (POI).

17. The apparatus of claim 1, wherein the at least one processor is further configured to cause the apparatus to receive a Privacy Override Indicator (POI) for the NTN service.

18. (canceled)

19. (canceled)

20. The apparatus of claim 1, wherein the received N1 message is a registration request, and the registration request includes an indication of the NTN service.

21. A method performed by an apparatus, the method comprising:
receiving an N1 message from a user equipment (UE) over a Non-Terrestrial Network (NTN) service;
sending a request to a unified data management (UDM) that includes a UE identifier (ID), an NTN service type, and an indication for a privacy information check;
receiving a response from the UDM with the UE ID, the NTN service type, and privacy information; and
responding to the N1 message based on the received privacy information.

22. An access and mobility function (AMF) for wireless communication, comprising:
at least one memory; and
at least one processor coupled with the at least one memory and configured to cause the AMF to:
receive an N1 message from a user equipment (UE) over a Non-Terrestrial Network (NTN) service;
send a request to a unified data management (UDM) which includes a UE identifier (ID), an NTN service type, and an indication for a privacy information check;
receive a response from the UDM with the UE ID, the NTN service type, and privacy information; and
respond to the N1 message based on the received privacy information.
